(19) United States
(12) Patent Application Publication
(10) Pub. No.: US 2016/0174283 A1
(43) Pub. Date: Jun. 16, 2016

(54) Method and Apparatus for Improving a Procedure for Connecting

(71) Applicant: NOKIA TECHNOLOGIES OY, Espoo (FI)

(72) Inventors: Lars Dalsgaard, Oulu (FI); Jussi-Pekka Koskinen, Oulu (FI); Ilkka Keskitalo, Oulu (FI); Jarkko Koskela, Oulu (FI)

(73) Assignee: Nokia Technologies Oy, Espoo (FI)

(21) Appl. No.: 14/909,234

(22) PCT Filed: Aug. 9, 2014
(86) PCT No.: PCT/IB2014/063813

§ 371 Date: Feb. 1, 2016

Related U.S. Application Data
(60) Provisional application No. 61/864,305, filed on Aug. 9, 2013.

(51) Int. Cl. H04W 76/02; H04W 36/36; H04W 48/16

(52) U.S. Cl. CPC H04W 76/028; H04W 48/16; H04W 36/36

(57) ABSTRACT

A method and apparatus can be configured to choose a cell. The method also includes choosing whether to use a convection establishment procedure or a connection re-establishment procedure. The method also includes performing the chosen procedure.

### BACKGROUND

1. Field

Embodiments of the invention relate to improving a procedure for connecting a user equipment with a serving cell.

2. Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method may comprise choosing a cell. The method can also include choosing whether to use a connection establishment procedure or a connection re-establishment procedure. The method can also include performing the chosen procedure.

In the method of the first embodiment, choosing whether to use the connection establishment procedure or the connection re-establishment procedure is based on a list of cells provided by a network.

In the method of the first embodiment, choosing whether to use the connection establishment procedure or the connection re-establishment procedure is based on a configured operation.

In the method of the first embodiment, choosing whether to use the connection establishment procedure or the connection re-establishment procedure is based on an estimation of whether or not the re-establishment would fail.

In the method of the first embodiment, the method may further include determining that a radio-link failure has occurred.

In the method of the first embodiment, determining that the radio-link failure has occurred comprises determining whether a user equipment has lost its connection to a corresponding serving cell.

In the method of the first embodiment, choosing the cell comprises choosing a cell that is the strongest from the perspective of a user equipment.

In the method of the first embodiment, the list of cells is signaled via a dedicated or broadcast channel.

In the method of the first embodiment, choosing the cell comprises choosing a cell not based on the strongest cell from the perspective of a user equipment but rather a cell that is included in the provided list.

In the method of the first embodiment, the chosen cell, that is not the strongest from the perspective of the user equipment, is no worse than a given amount below the strongest cell.

In the method of the first embodiment, checking whether the chosen cell is included on the list comprises checking whether the chosen cell is on a list of cells with user-equipment context.

In the method of the first embodiment, checking whether the chosen cell is included on the list comprises checking whether the chosen cell is on, or is compatible with, a list comprising at least one of cells, carriers, frequencies, radio-access-technologies, tracking areas, physical-cell identities, and enhanced-cell-global identities for a user equipment to connect with.

In the method of the first embodiment, a cell-selection procedure is used when the list of cells is empty or the list has not been provided by the network.

According to a second embodiment, an apparatus comprises at least one processor. The apparatus can include at least one memory including computer program code. The at least one memory and the computer program code can be configured, with the at least one processor, to cause the apparatus at least to choose a cell. The apparatus can choose whether to use a connection establishment procedure or a connection re-establishment procedure. The apparatus can perform the chosen procedure.

In the apparatus of the second embodiment, choosing whether to use the connection establishment procedure or the connection re-establishment procedure is based on a list of cells provided by a network.

In the apparatus of the second embodiment, choosing whether to use the connection establishment procedure or the connection re-establishment procedure is based on a configured operation.

In the apparatus of the second embodiment, choosing whether to use the connection establishment procedure or the connection re-establishment procedure is based on an estimation of whether or not the re-establishment would fail.

In the apparatus of the second embodiment, the apparatus may be further caused to determine that a radio-link failure has occurred.

In the apparatus of the second embodiment, determining that the radio-link failure has occurred comprises determining whether the apparatus has lost its connection to a corresponding serving cell.

In the apparatus of the second embodiment, choosing the cell comprises choosing a cell that is the strongest from the perspective of the apparatus.

In the apparatus of the second embodiment, the list of cells is signaled via a dedicated or broadcast channel.

In the apparatus of the second embodiment, choosing the cell comprises choosing a cell not based on the strongest cell from the perspective of the apparatus but rather a cell that is included in the provided list.

In the apparatus of the second embodiment, the chosen cell, that is not the strongest from the perspective of the apparatus, is no worse than a given amount below the strongest cell.

In the apparatus of the second embodiment, checking whether the chosen cell is included on the list comprises checking whether the chosen cell is on a list of cells with user-equipment context.

In the apparatus of the second embodiment, checking whether the chosen cell is included on the list comprises checking whether the chosen cell is on, or compatible with, a list comprising at least one of cells, carriers, frequencies, radio-access-technologies, tracking areas, physical-cell identities, and enhanced-cell-global identities for the apparatus to connect with.

In the apparatus of the second embodiment, a cell-selection procedure is used when the list of cells is empty or the list has not been provided by the network.

According to a third embodiment, a computer program product can be embodied on a non-transitory computer readable medium. The computer program product can be configured to control a processor to perform a process. The process can comprise choosing a cell. The process can also include choosing whether to use a connection establishment procedure or a connection re-establishment procedure. The process can also include performing the chosen procedure.

According to a fourth embodiment, an apparatus may include first choosing means that chooses a cell. The apparatus may also include second choosing means that chooses whether to use a connection establishment procedure or a connection re-establishment procedure. The apparatus may also include performing means that performs the chosen procedure.

In the apparatus of the fourth embodiment, choosing whether to use the connection establishment procedure or the connection re-establishment procedure is based on a list of cells provided by a network.

In the apparatus of the fourth embodiment, choosing whether to use the connection establishment procedure or the connection re-establishment procedure is based on a configured operation.

In the apparatus of the fourth embodiment, choosing whether to use the connection establishment procedure or the connection re-establishment procedure is based on an estimation of whether or not the re-establishment would fail.

In the apparatus of the fourth embodiment, the apparatus may also include determining means that determine that a radio-link failure has occurred.

In the apparatus of the fourth embodiment, determining that the radio-link failure has occurred comprises determining whether a user equipment has lost its connection to a corresponding serving cell.

In the apparatus of the fourth embodiment, choosing the cell comprises choosing a cell that is the strongest from the perspective of a user equipment.

In the apparatus of the fourth embodiment, the list of cells is signaled via a dedicated or broadcast channel.

In the apparatus of the fourth embodiment, choosing the cell comprises choosing a cell not based on the strongest cell from the perspective of a user equipment but rather a cell that is included in the provided list.

In the apparatus of the fourth embodiment, the chosen cell, that is not the strongest from the perspective of the user equipment, is no worse than a given amount below the strongest cell.

In the apparatus of the fourth embodiment, checking whether the chosen cell is included on the list comprises checking whether the chosen cell is on a list of cells with user-equipment context.

In the apparatus of the fourth embodiment, checking whether the chosen cell is included on the list comprises checking whether the chosen cell is on, or is compatible with, a list comprising at least one of cells, carriers, frequencies, radio-access-technologies, tracking areas, physical-cell identities, and enhanced-cell-global identities for a user equipment to connect with.

In the apparatus of the fourth embodiment, a cell-selection procedure is used when the list of cells is empty or the list has not been provided by the network.

### BRIEF DESCRIPTION OF THE DRAWINGS

For proper understanding of the invention, reference should be made to the accompanying drawings, wherein:

FIG. 1 illustrates a user equipment and a plurality of cells in accordance with embodiments of the invention.

FIG. 2 illustrates a flowchart of a method in accordance with embodiments of the invention.

FIG. 3 illustrates an apparatus in accordance with embodiments of the invention.

FIG. 4 illustrates an apparatus in accordance with embodiments of the invention.

### DETAILED DESCRIPTION

Embodiments of the present invention relate to technologies that use an Evolved-Universal-Terrestrial-Radio-Network (E-UTRAN) Radio-Resource-Control (RRC) connected mode. Embodiments of the present invention also relate to heterogeneous networks and networks that deploy small cells. Embodiments of the present invention improve the procedure for re-establishing a connection between a user equipment (UE) and a cell, in the event that the UE loses connection to the corresponding serving cell. The user equipment can lose connection to its corresponding serving cell, for example, due to a radio-link failure (RLF).

Current technical discussions that relate to heterogeneous networks (HetNets) are often directed to improving procedures for re-establishing a connection between a UE and a cell in the event that the UE experiences a procedure failure or connection failure, for example, a RLF. Once a procedure or connection failure occurs, the UE may go to idle and start a cell-selection process. When a suitable cell(s) is found, the UE may initiate a re-establishment procedure. In these previous approaches, the UE performs a cell-selection procedure and selects the suitable cell based on the results of the cell-selection procedure.

A proposal for improving the re-establishment procedure can include providing the UE with a list of prepared cells. The prepared cells can be cells with which the UE can re-establish a connection with. This list of prepared cells can inform the UE which cells have the proper UE context for a connection. A UE context can be considered to be a set of parameters that are used by a cell to associate with a UE. If a particular cell has the UE context of a UE, it can be generally assured that a re-establishment procedure between the UE and particular cell will succeed.

In one embodiment, the prepared cells included within the list of prepared cells can be determined in different ways, e.g., it can be based on a UE measurement report. The UE measurement report can include measurements conducted by a UE. In another embodiment, this list can be determined without measurement reporting by any UE. For example, the list can be determined without measurement reporting when local small-cells are deployed under macro coverage.

The UE can be configured to choose the cell to re-establish a connection with, the cell being chosen from a list of prepared cells. However, if the UE chooses a cell from a list of prepared cells, some constraints are generally added to the UE cell-selection procedure. For example, the UE cell-selection procedure is generally limited to selecting a best/strongest/most-suitable cell, as determined from the point of view of the UE, at the time when the RLF occurs.

When the UE determines the current best/strongest/most-suitable cell to be used for re-establishing the connection to, although information based on earlier measurement reporting can be fairly accurate, radio conditions may have changed between the sending of the measurements by the UE, the receiving of the list of prepared cells by the UE, and the time when RLF actually occurs. Therefore, by the time the UE performs the cell-selection procedure in response to RLF, the radio conditions surrounding the UE may be different than the conditions that existed at the time when the measurement report was sent by the UE.

For example, a UE can send a measurement report while being on a first floor, the UE can then lose service (for example, experience RLF) due to entering an elevator, and the UE can finally try to perform a cell-selection procedure once the UE reaches a different floor (upon exiting the elevator). However, radio conditions of the first floor may be different than the radio conditions of the different floor that is reached upon exiting the elevator.

In view of the above, embodiments of the present invention enable a UE to use preconfigured information relating to prepared cells, while, at the same time, not restricting the UE during the UE's cell-selection procedure. Embodiments of the present invention also allow the UE to perform the cell-selection procedure based on the radio conditions at the time that RLF actually occurs.

In embodiments of the present invention, the UE can perform a connection establishment, as opposed to only performing a connection re-establishment. Specifically, the UE can perform/start/initiate a Radio-Resource-Control (RRC) connection establishment, instead of an RRC connection re-establishment.

Embodiments of the present invention can perform RRC connection establishment, instead of RRC connection re-establishment, when the UE is configured by a relevant network for this behavior. The UE can be configured by dedicated or broadcast signaling, for example.

Embodiments of the present invention can also perform RRC connection establishment, instead of RRC connection re-establishment, when the UE is aware that a connection re-establishment would likely fail. For example, the UE may become aware that a connection re-establishment with a particular cell would likely fail if the UE determines that the particular cell does not have UE context.

Embodiments of the present invention can also perform RRC connection establishment, instead of RRC connection re-establishment, when the UE selects a cell that is not included-in/compatible-with a list of re-establishment candidates. The list can include, for example, the cell(s)/carrier(s)/frequency(s)/Radio-Access-Technologies (RAT(s))/Tracking Areas (TA(s))/Physical Cell Identities (PCI(s))/enhanced-cell-global identities (ECGI) that the UE should perform connection to during re-establishment.

Embodiments of the present invention can also perform RRC connection establishment, instead of RRC connection re-establishment, when the UE has selected/detected a strongest cell which is not included in the provided list. The strongest cell can, e.g., be considered to be the cell with the strongest signal level, signal strength or signal quality and alike, as received/perceived by the UE.

Embodiments of the present invention can also perform RRC connection establishment, instead of RRC connection re-establishment, when the list of re-establishment candidates provided to the UE is empty

Embodiments of the present invention can also perform RRC connection establishment, instead of RRC connection re-establishment, when the network does not provide a re-establishment candidates list to the UE.

Embodiments of the present invention can also perform RRC connection establishment, instead of RRC connection re-establishment, when the behavior of performing is statically specified in the specifications that govern the UE or if so configured by network.

Embodiments of the present invention can also perform RRC connection establishment, instead of RRC connection re-establishment, in the event that any combination of the above occurs.

In embodiments of the present invention, the UE can perform basic cell-selection but, after having detected the strongest (and potentially suitable) cell on the carrier, the UE can check if the detected strongest cell is part of the network-configured list of prepared cells. As described above, the network configured list of prepared cells can be cells which have UE context (and which the re-establishment procedure can be performed successfully). If the detected strongest cell is part of the network-configured list of prepared cells, then the UE can perform re-establishment. On the other hand, if the detected strongest cell is not part of the network-configured list of prepared cells, the UE can perform regular connection establishment directly without trying any connection re-establishment. Connection re-establishment is not tried because the connection re-establishment would likely fail. The connection re-establishment would likely fail because the chosen/detected strongest cell does not have UE context, as the chosen cell is not a part of the configured list of prepared cells.

As described above, the network can provide the UE with a list of prepared cells that the UE can use/connect-with in the event that RLF occurs. After RLF occurs, the UE chooses one of the cells on the list and use that cell for re-establishment. The UE can choose the strongest available cell among the listed cells.

However, it may not be beneficial to restrict the UE's selection to choosing only the (strongest) cells available within the list of prepared cells. Such a restriction may result in the UE choosing a cell for re-establishment which is not the best-suited for connection. If UE cell selection is restricted to members of the list of prepared cells, which may, in fact, not contain the actually strongest cell available at the time of the procedure, the UE may end up on a cell which is not the best available cell. Choosing a cell which is not the best cell for connection or communication with network will generally lead to several drawbacks. The drawbacks can include an increased amount of interference. The UE may need to use higher uplink (UL) transmission (TX) power than needed, and the network may need to use a higher-than-necessary downlink (DL) transmission (TX) power to overcome the interference.

If the UE chooses a cell for re-establishment which is not the best-suited for connection, the choosing of this cell will most likely lead to a handover (HO) immediately after the re-establishment, thereby increasing the signaling and potential failures because the UE is not on a best-suited cell.

Embodiments of the present invention can overcome the problem of connecting to cells that are not the best-suited cell, while at the same time improve re-establishment in the event that the best-suited cell is actually on the list of prepared cells.

In one embodiment of the present invention, an RLF occurs and a UE begins a cell-selection procedure. When the UE has detected a strongest cell on the carrier, (1) the UE checks whether the detected strongest cell is included in a configured list of prepared cells, (2) if the cell is on the list, the UE performs connection re-establishment, and (3) if the cell is not on the list, the UE performs connection establishment.

In view of the above, embodiments of the present invention provide a robust re-establishment procedure by providing the UE with a list of prepared cells (cells which have the UE context), for example. The UE can perform a cell-selection procedure, where the UE, based on, e.g., current cell selection procedure and algorithm, the current radio condition, can choose the best cell. Embodiments of the present invention allow the UE to use either connection re-establishment or connection establishment, based on whether or not the chosen cell was in the list of prepared cells.

Embodiments of the present invention can also detect more than one cell. For example, embodiments of the present invention can detect two cells. If the second best cell is on the list while the best cell of the detected cells is not, the UE could still be allowed to use this second best cell for connection re-establishment, under certain given conditions. Examples of such conditions could be that the network has indicated that the UE may behave like this and/or the network has configured the UE with a given decision threshold. For example, the threshold may be based upon having the second best cell being less than 3 dB worse than the best cell. If the second-best cell is not more than 3 dB worse, the second-best cell can be used for connection re-establishment.

Because the network would generally need to have knowledge concerning the RLF, it may also be necessary for the UE to send information relating to the RLF in the connection-establishment message.

In view of the above, in embodiments of the invention, a UE can use an appropriate procedure to connect to a serving cell after RLF occurs. Embodiments can improve call re-establishment. Embodiments can improve connection establishment. Connection recovery can be faster in cases where the chosen cell is not prepared with UE context. Embodiments of the present invention can provide a UE with a list of prepared cells. Embodiments of the present invention can ensure that a UE will not start re-establishment on a cell which is not the best cell.

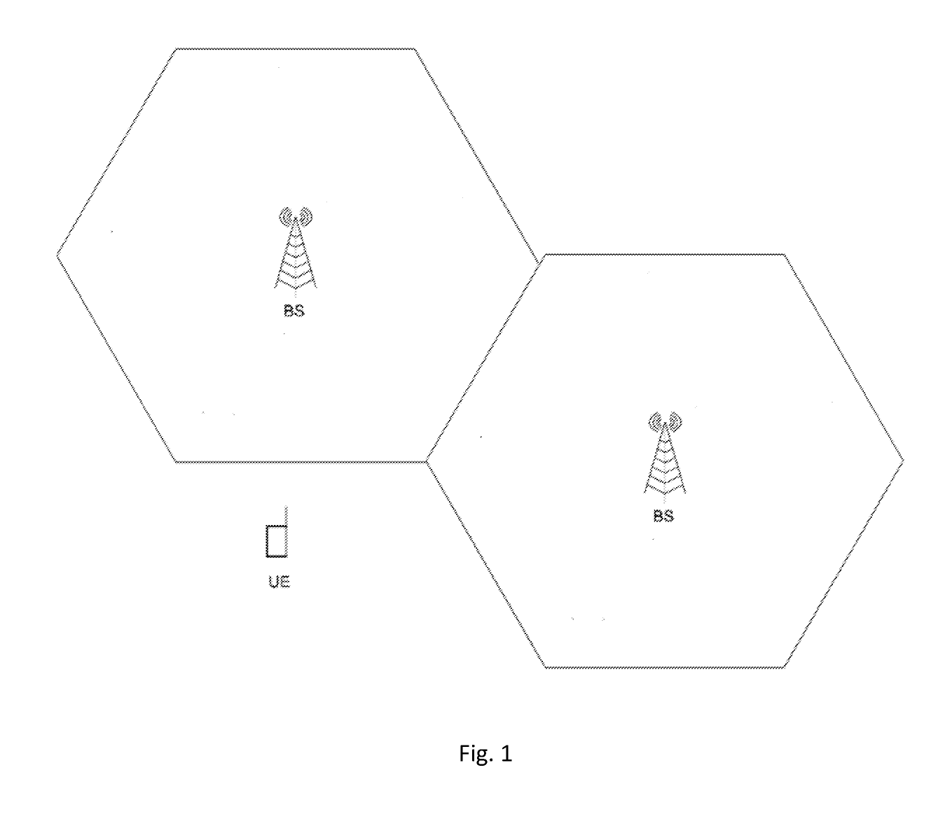

FIG. 1 illustrates a user equipment and a plurality of cells in accordance with embodiments of the invention. As described above, a user equipment can be served by a particular cell. However, the user equipment can experience radio-link failure with the particular serving cell. Thus, the user equipment may reconnect with the original serving cell or may connect to a different cell.

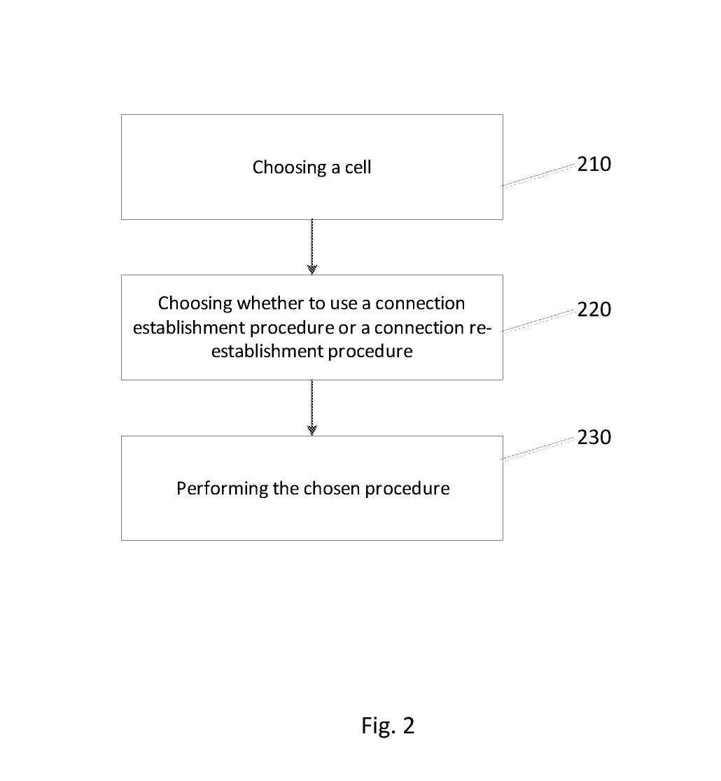

FIG. 2 illustrates a flowchart of a method in accordance with an embodiment of the invention. The method includes, at 210, choosing a cell. The method also includes, at 220, choosing whether to use a connection establishment procedure or a connection re-establishment procedure. The method also includes, at 230, performing the chosen procedure.

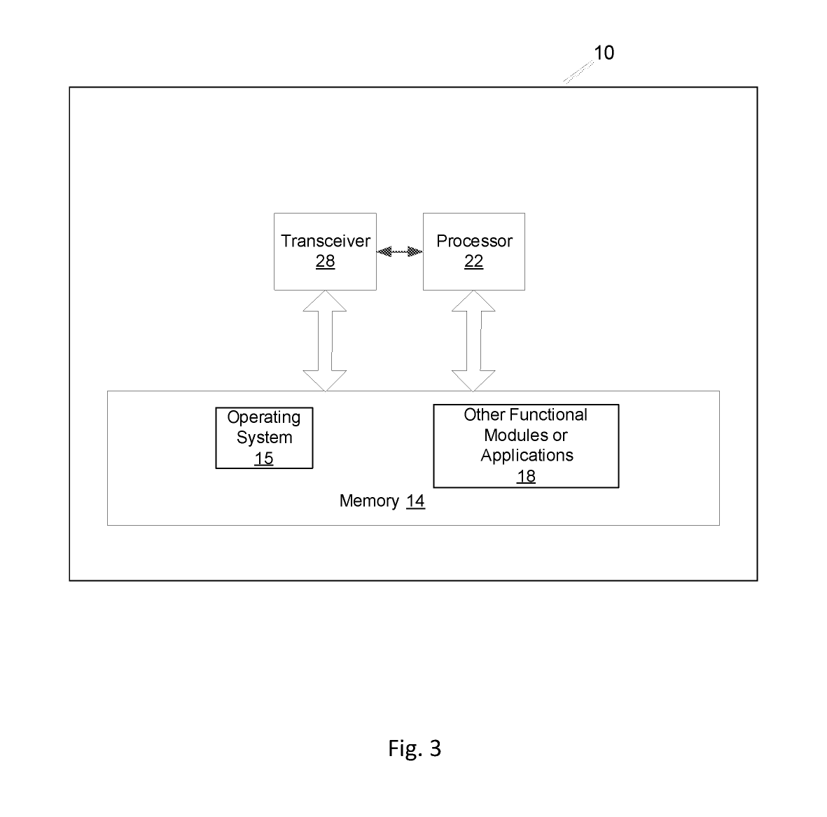

FIG. 3 illustrates an apparatus in accordance with an embodiment of the invention. Apparatus 10 can include a processor 22 for processing information and executing instructions or operations. Processor 22 can be any type of general or specific purpose processor. While a single processor 22 is shown in FIG. 3, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

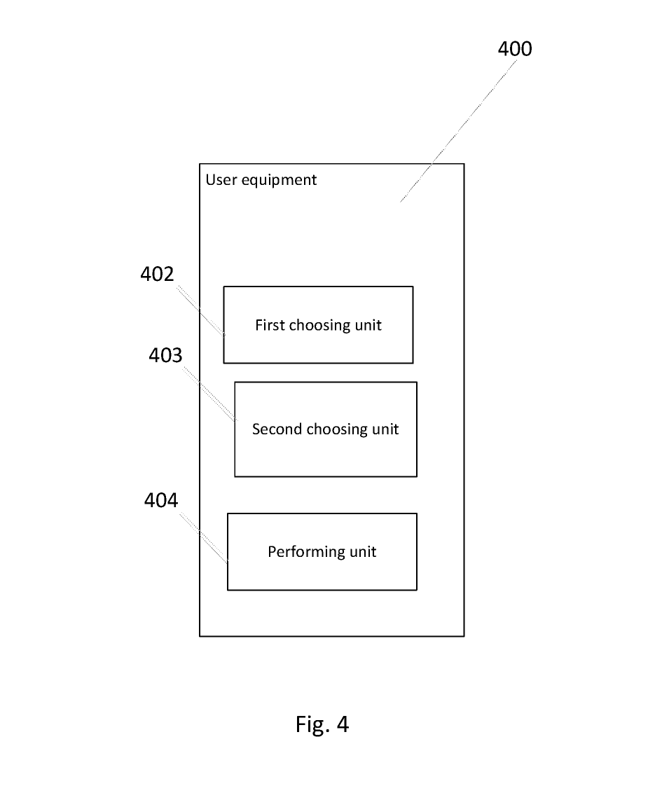

FIG. 4 illustrates an apparatus in accordance with another embodiment. Apparatus 400 can be a user equipment, for example. Apparatus 400 can include a first choosing unit 402 that chooses a cell. Apparatus 400 can also include a second choosing unit 403 that chooses whether to use a connection establishment procedure or a connection re-establishment procedure. Apparatus 400 can also include a performing unit 404 that performs the chosen procedure.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-27. (canceled)

28. A method, comprising:
choosing a cell;
choosing whether to use a connection establishment procedure or a connection re-establishment procedure; and
performing the chosen procedure.

29. The method according to claim 28, wherein choosing whether to use the connection establishment procedure or the connection re-establishment procedure is based on checking at least one of a list of cells provided by a network, a configured operation, and an estimation of whether or not the re-establishment would fail.

30. The method according to claim 28, further comprising determining that a radio-link failure has occurred.

31. The method according to claim 30, wherein determining that the radio-link failure has occurred comprises determining whether a user equipment has lost its connection to a corresponding serving cell.

32. The method according to claim 28, wherein choosing the cell comprises choosing a cell that is the strongest from the perspective of a user equipment.

33. The method according to claim 29, wherein the list of cells is signaled via a dedicated or broadcast channel.

34. The method according to claim 29, wherein choosing the cell comprises choosing a cell not based on the strongest cell from the perspective of a user equipment but rather a cell that is included in the provided list.

35. The method according to claim 34, wherein the chosen cell, that is not the strongest from the perspective of the user equipment, is no worse than a given amount below the strongest cell.

36. The method according to claim 29, wherein checking whether the chosen cell is included on the list comprises at least one of checking whether the chosen cell is on a list of cells with user-equipment context, and checking whether the chosen cell is on, or is compatible with, a list comprising at least one of cells, carriers, frequencies, radio-access-technologies, tracking areas, physical-cell identities, and enhanced-cell-global identities for a user equipment to connect with.

37. The method according to claim 29, wherein a cell-selection procedure is used when the list of cells is empty or the list has not been provided by the network.

38. An apparatus, comprising:
at least one processor; and
at least one memory including computer program code,
the at least one memory and the computer program code configured, with the at least one processor, to cause the apparatus at least to
choose a cell;
choose whether to use a connection establishment procedure or a connection re-establishment procedure; and
perform the chosen procedure.

39. The apparatus according to claim 38, wherein the apparatus is caused to choose whether to use the connection establishment procedure or the connection re-establishment procedure based on checking at least one of a list of cells provided by a network, a configured operation, and an estimation of whether or not the re-establishment would fail.

40. The apparatus according to claim 38, wherein the apparatus is further caused to determine that a radio-link failure has occurred.

41. The apparatus according to claim 38, wherein the apparatus is caused to choose the cell by choosing a cell that is the strongest from the perspective of the apparatus.

42. The apparatus according to claim 39, wherein the list of cells is signaled via a dedicated or broadcast channel.

43. The apparatus according to claim 39, wherein the apparatus is caused to choose the cell by choosing a cell not based on the strongest cell from the perspective of the apparatus but rather a cell that is included in the provided list.

44. The apparatus according to claim 43, wherein the chosen cell, that is not the strongest from the perspective of the apparatus, is no worse than a given amount below the strongest cell.

45. The apparatus according to claim 39, wherein the apparatus is caused to check whether the chosen cell is included on the list by at least one of checking whether the chosen cell is on a list of cells with user-equipment context, and checking whether the chosen cell is on, or compatible with, a list comprising at least one of cells, carriers, frequencies, radio-access-technologies, tracking areas, physical-cell identities, and enhanced-cell-global identities for the apparatus to connect with.

46. The apparatus according to claim 39, wherein a cell-selection procedure is used when the list of cells is empty or the list has not been provided by the network.

47. A computer program product, embodied on a non-transitory computer readable medium, the computer program product configured to control a processor to perform a process, comprising:
choosing a cell;
choosing whether to use a connection establishment procedure or a connection re-establishment procedure; and
performing the chosen procedure.
